(19) United States
(12) Patent Application Publication
(10) Pub. No.: US 2021/0245368 A1
(43) Pub. Date: Aug. 12, 2021

(54) METHOD FOR VIRTUAL INTERACTION, PHYSICAL ROBOT, DISPLAY TERMINAL AND SYSTEM

(71) Applicant: SZ DJI TECHNOLOGY CO., LTD., Shenzhen (CN)

(72) Inventor: Lijian LIU, Shenzhen (CN)

(21) Appl. No.: 17/242,249

(22) Filed: Apr. 27, 2021

Related U.S. Application Data
(63) Continuation of application No. PCT/CN2018/118934, filed on Dec. 3, 2018.

(30) Foreign Application Priority Data
Oct. 31, 2018 (CN) 201811291700.5

(51) Int. Cl. B25J 11/00; G06F 3/01; G06F 3/0484; G06F 3/16; B25J 13/00; B25J 13/08

(52) U.S. Cl. CPC B25J 11/0005; G06F 3/011; G06F 3/0484; B25J 13/081; G06F 3/167; B25J 13/006; B25J 13/088; G06F 3/017

(57) ABSTRACT

The present disclosure provides a method for virtual interaction, a physical robot, a display terminal, and a system to enhance man-machine interaction experience. The method for virtual interaction includes: acquiring data measured by at least one sensor of a first physical robot from performing measurement at a real scene within a current measurement range, where the current measurement range changes with a movement of the first physical robot in the real scene; and drawing, according to the data measured by the at least one sensor, a virtual scene corresponding to the real scene within the current measurement range, and displaying the virtual scene on a display terminal.

### CROSS-REFERENCES TO RELATED APPLICATIONS

This application is a continuation of International Application No. PCT/CN2018/118934, filed Dec. 3, 2018, which claims priority to Chinese patent application No. 201811291700.5 filed with the Chinese Patent Office on Oct. 31, 2018, the entire content of both of which are incorporated herein by reference.

### FIELD OF THE DISCLOSURE

The present disclosure relates to the field of robotics, and, more particularly, relates to a method for virtual interaction, a physical robot, a display terminal, and a system.

### BACKGROUND

With a popularity of robots, there are more and more scenarios where people need to interact with robots in their daily work and life.

A common scenario is that a user and a physical robot are in a same real scene and a distance between the two is relatively close. The user uses a remote control to remotely control the physical robot. However, the above man-machine interaction method requires that the distance between the user and the physical robot cannot exceed a coverage range of a remote-control signal. If the distance between the user and the physical robot exceeds the coverage of the remote-control signal, the man-machine interaction method cannot be used.

Another common scenario is to simulate a user's interaction with a virtual robot in a virtual scene. However, the virtual scene in this kind of man-machine interaction is designed in advance and has nothing to do with a real scene. Therefore, a user experience is not real enough.

### BRIEF SUMMARY OF THE DISCLOSURE

The present disclosure provides a virtual interaction method, a physical robot, a display terminal, and a system to optimize man-machine interaction experience.

One aspect of the embodiments of the present disclosure provides a virtual interaction method. The method includes acquiring data measured by at least one sensor on a first physical robot from performing measurement at a real scene within a current measurement range, wherein the current measurement range changes with a movement of the first physical robot in the real scene; and drawing, according to the data measured by the at least one sensor, a virtual scene corresponding to the real scene within the current measurement range and displaying the virtual scene on a display terminal.

Another aspect of the embodiments of the present disclosure provides a first physical robot including at least one sensor configured to perform measurement at a real scene within a current measurement range, wherein the current measurement range changes with a movement of the first physical robot in the real scene; and a processor connected to the at least one sensor, configured to acquire data measured by the at least one sensor from performing the measurement at the real scene within the current measurement range, and draw, according to the data measured by the at least one sensor, a virtual scene corresponding to the real scene within the current measurement range, the virtual scene being displayed on a display terminal.

Another of the embodiments of the present disclosure provides a display terminal including a communication component configured to communicate with a first physical robot to acquire data measured by at least one sensor of the first physical robot from performing measurement at a real scene within a current measurement range, wherein the current measurement range changes with a movement of the first physical robot in the real scene. The display terminal also includes a processor configured to draw, according to the data measured by the at least one sensor, a virtual scene corresponding to the real scene within the current measurement range, and a display component connected to the processor, configured to display the virtual scene corresponding to the real scene within the current measurement range.

A fourth aspect of the embodiments of the present disclosure provides a virtual interaction system. The interaction system includes a first physical robot with at least one sensor configured to perform measurement at a real scene within a current measurement range, and a data processing server, connected to the first physical robot, configured to execute the method described in the first aspect of the present disclosure.

A fifth aspect of the embodiments of the present disclosure provides a computer readable storage medium on which a computer program is stored. When the program is executed by a processor, steps in the method described in the first aspect of the present disclosure are implemented.

Using the above technical solution, according to data measured by a sensor on a physical robot from performing measurement at a real scene within a current measurement range, a corresponding virtual scene is drawn and displayed on a display terminal. A user can truly experience the real scene around the physical robot by watching the virtual scene displayed on the display terminal, thereby achieving an effect of bringing the user into the real scene around the physical robot. The technical solution does not limit a distance between the user and the physical robot to be within a coverage range of a remote-control signal. The technical solution does not limit that the user and the physical robot must be in a same real scene, either. As the physical robot moves in the real scene, data measured by a sensor on the physical robot from performing measurement at the real scene within the current measurement range changes synchronously. The drawn virtual scene also changes synchronously and is displayed on the display terminal. The user can experience the real scene around the physical robot in real time by watching the real-time changing virtual scene displayed on the display terminal.

### BRIEF DESCRIPTION OF THE DRAWINGS

In order to more clearly describe technical solutions of various embodiments of the present disclosure, the following will briefly introduce drawings that need to be used in the description of the various embodiments of the present disclosure. Obviously, the drawings in a following description are only some embodiments of the present disclosure. For those skilled in the art, other drawings can be acquired based on the drawings without creative efforts.

FIG. 1 illustrates a flowchart of a virtual interaction method according to an embodiment of the present disclosure;

FIG. 2 illustrates a flowchart of a virtual interaction method according to another embodiment of the present disclosure;

FIG. 3 illustrates a flowchart of a virtual interaction method according to another embodiment of the present disclosure;

FIG. 4 illustrates a flowchart of a virtual interaction method according to another embodiment of the present disclosure;

FIG. 5 illustrates a flowchart of a virtual interaction method according to another embodiment of the present disclosure;

FIG. 6 illustrates a schematic diagram of a physical robot according to an embodiment of the present disclosure;

FIG. 7 illustrates a schematic diagram of a display terminal according to an embodiment of the present disclosure; and

FIG. 8 illustrates a schematic diagram of a virtual interaction system according to an embodiment of the present disclosure.

### DETAILED DESCRIPTION

Technical solutions of the present disclosure will be clearly and completely described below in conjunction with embodiments and accompanying drawings in the embodiments. Obviously, the described embodiments are only part of embodiments of the present disclosure, rather than all the embodiments. Based on the embodiments in the present disclosure, all other embodiments acquired by those skilled in the art without creative efforts shall fall within a protection scope of the present disclosure.

First, an embodiment of the present disclosure provides a virtual interaction method, and the method can be executed by a processor having information processing functions. The processor may be set in a physical robot (e.g., a first physical robot in the following embodiments of the present disclosure, any physical robot besides the first physical robot). The processor can also be set in a display terminal (e.g., a terminal with both display function and information processing function). Alternatively, the processor can be set in a data processing server (e.g., a server with data processing functions)

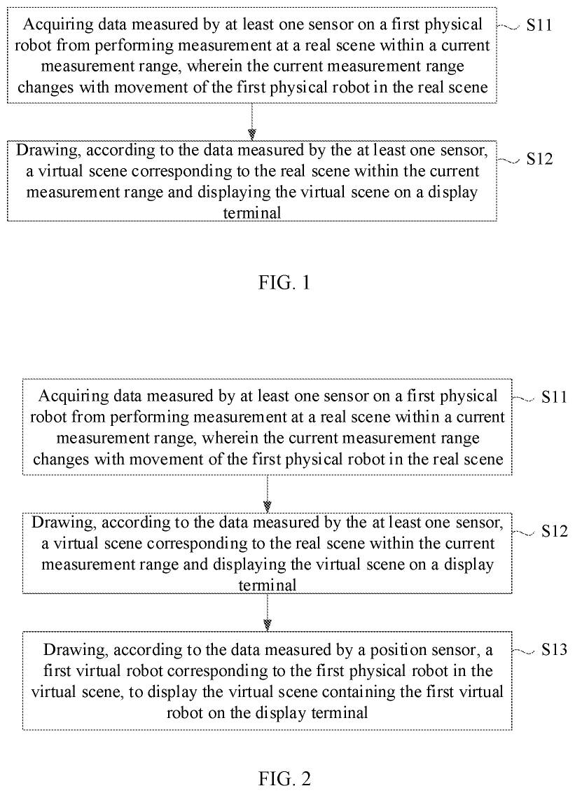

Referring to FIG. 1, FIG. 1 illustrates a flowchart of a virtual interaction method according to an embodiment of the present disclosure. As shown in FIG. 1, the method includes following steps.

Step S11: acquiring data measured by at least one sensor on a first physical robot from performing measurement at a real scene within a current measurement range, where the current measurement range changes with movement of the first physical robot in the real scene.

Step S12: drawing, according to the data measured by the at least one sensor, a virtual scene corresponding to the real scene within the current measurement range and displaying the virtual scene on a display terminal.

In one embodiment, at least one sensor is provided on the first physical robot. The at least one sensor configured to perform measurement at a real scene around the first physical robot may be a real scene measurement sensor. For example, the at least one sensor includes, but is not limited to an image sensor, a camera, an angular velocity sensor, an infrared sensor, a lidar, or the like. Correspondingly, data measured by at least one sensor of the first physical robot includes but is not limited to depth data, orientation data, color data, or the like.

It is understandable that as the first physical robot moves in the real scene, the current measurement range of the at least one sensor changes accordingly. For example, suppose the first physical robot is walking in a house in a real world, as the first physical robot moves from a southeast corner of the house to a northwest corner of the house, a current measurement range of at least one sensor also changes from the southeast corner of the house to the northwest corner of the house. Correspondingly, data obtained by the at least one sensor on the first physical robot also changes accordingly. In other words, the data measured by the at least one sensor changes in real time, is synchronized with the real scene around the first physical robot and is data that characterizes the real scene around the first physical robot.

After the data measured by at least one sensor on the first physical robot is obtained, step S12 is executed to draw the virtual scene corresponding to the real scene within the current measurement range of the at least one sensor. For a specific method of drawing the virtual scene, reference may be made to related technologies. It is understandable that as the data measured by the at least one sensor in step S11 changes in real time, the corresponding virtual scene drawn also changes in real time and is synchronized with the real scene around the first physical robot. The drawn virtual scene will be displayed on the display terminal.

Using the above technical solution, according to data measured by a sensor on a physical robot from performing measurement at a real scene within a current measurement range, a corresponding virtual scene is drawn and displayed on a display terminal. A user can truly experience the real scene around the physical robot by watching the virtual scene displayed on the display terminal, thereby achieving an effect of bringing the user into the real scene around the physical robot. The technical solution does not limit a distance between the user and the physical robot to be within a coverage range of a remote-control signal, nor does it limit that the user and the physical robot must be in a same real scene. As the physical robot moves in the real scene, a sensor on the physical robot measures the real scene within the current measurement range and the measured data changes synchronously. The drawn virtual scene also changes synchronously and is displayed on the display terminal. The user can experience the real scene around the physical robot in real time by watching the real-time changing virtual scene displayed on the display terminal.

With reference to the above embodiment, in another embodiment of the present disclosure, the at least one sensor includes a position sensor. Referring to FIG. 2, FIG. 2 illustrates a flowchart of a virtual interaction method according to another embodiment of the present disclosure. As shown in FIG. 2, the method includes a following step in addition to step S11 and S12.

Step S13: drawing, according to position data measured by a position sensor, a first virtual robot corresponding to the first physical robot in the virtual scene, to display the virtual scene containing the first virtual robot on the display terminal.

Wherein, movements of the first virtual robot in the virtual scene is synchronized with movements of the first physical robot in the real scene.

In one embodiment, at least one sensor further includes the position sensor. Therefore, according to the position data measured by the position sensor, after step S12 is executed, the first virtual robot corresponding to the first physical robot can continued to be drawn in the drawn virtual scene. The correspondence between the first physical robot and the first virtual robot means: movement of the first physical robot in the real scene is synchronized with movement of the first virtual robot in the drawn virtual scene. That is, the first virtual robot is an imaging robot acquired by mapping the first physical robot to the drawn virtual scene.

It is understandable that as the first physical robot moves in the real scene, the data acquired by the position sensor on the first physical robot also changes. As the position data measured by the position sensor on the first physical robot changes in real time, the first virtual robot drawn by executing step S13 also changes in real time and is synchronized with movement of the first physical robot.

By applying the above technical solution, a virtual robot corresponding to a physical robot is superimposed on a drawn virtual scene and displayed on a display terminal. A user can watch the virtual scene containing the virtual robot displayed on the display terminal. On one hand, the real scene around the physical robot is truly experienced and the position of the real robot in its surrounding real scene is known. On the other hand, since the virtual scene contains the virtual robot, a visual interest is improved.

As the physical robot moves in the real scene, the position data measured by the position sensor on the physical robot changes synchronously. The drawn virtual robot also moves synchronously and is displayed on the display terminal. A user can visually perceive movement of the physical robot in the real scene in real time by watching the virtual robot moving in synchronization with the physical robot displayed on the display terminal.

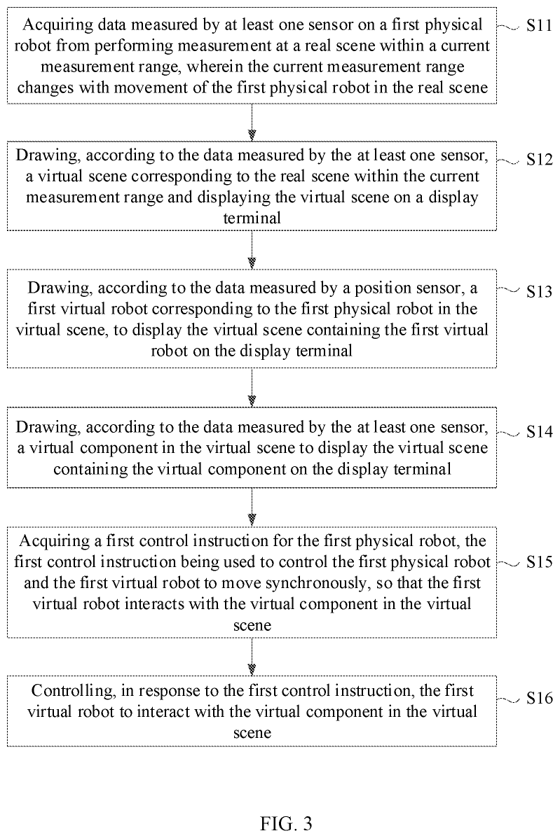

With reference to the above embodiment, in another embodiment of the present disclosure, referring to FIG. 3, FIG. 3 illustrates a flowchart of a virtual interaction method according to another embodiment of the present disclosure. As shown in FIG. 3, the method includes following steps in addition to steps S11-S13.

Step S14: drawing, according to the data measured by the at least one sensor, a virtual component in the virtual scene to display the virtual scene containing the virtual component on the display terminal.

Step S15: acquiring a first control instruction for the first physical robot, the first control instruction being configured to control the first physical robot and the first virtual robot to move synchronously, so that the first virtual robot interacts with the virtual component in the virtual scene. In one embodiment, in response to the first control instruction (e.g., making a movement), the first physical robot is configured to perform a physical action (e.g., making a physical movement), and the processor is configured to draw an updated virtual robot (e.g., making a virtual movement corresponding to the physical movement) in the virtual scene.

Step S16: controlling, in response to the first control instruction, the first virtual robot to interact with the virtual component in the virtual scene.

In one embodiment, the virtual component is a virtual component with interactive functions. Specifically, the virtual component is a virtual component with interactive functions drawn according to the data measured by the at least one sensor on the first physical robot. In one embodiment, the virtual component may have a corresponding physical entity in the same real scene as the first physical robot. In another embodiment, the virtual component may not have a corresponding physical entity. In some embodiments, the interactive functions of the virtual component may refer to performing different actions on the virtual component according to different user operations, such as changing viewing perspectives of the virtual component, moving the virtual component in the virtual scene, making the virtual component as a virtual target of the first virtual robot (e.g., a virtual target destination that first virtual robot needs to reach, a virtual target obstacle that the first virtual robot needs to avoid, a virtual target object that the first virtual robot needs to capture, etc.). In some examples, making the virtual component as the virtual target of the first virtual robot may also trigger the processor to make the physical entity corresponding to the virtual component as a physical target of the first physical robot.

In one embodiment, after step S12 is executed, the virtual component can be drawn continuously in the drawn virtual scene. Thus, the virtual component is superimposed on the drawn virtual scene and displayed on the display terminal. On one hand, by watching the virtual scene containing virtual components displayed on the display terminal, a user can truly experience the real scene around the physical robot. On the other hand, since the virtual scene contains a virtual robot, a visual interest is improved.

In another implementation manner, after step S12 is executed, a virtual component can also be drawn in a real scene around a user. Thus, on the one hand, by watching the virtual scene displayed on the display terminal, the user can truly experience the real scene around the physical robot. On the other hand, the user can also see the virtual component in the real scene around themselves, which is convenient for the user to combine the virtual scene that the user sees and the virtual component, thereby improving the visual richness and interest.

In one embodiment, a virtual scene containing a virtual component is displayed on the display terminal. By watching the virtual scene containing the virtual component displayed on the display terminal, if a user wants to experience an interactive function of the virtual component, the user can perform a control operation on the first physical robot, so that the processor executes step S15 to acquire a first control instruction.

In another embodiment, there are one or more second physical robots in a real scene where the first physical robot is located. That is, there are a plurality of physical robots in a same real scene as the first physical robot. If a user wants to experience an interaction of the plurality of physical robots in a same real scene in a drawn virtual scene, the user can perform a control operation on the first physical robot so that the processor executes a step like S15 to acquire a second control instruction.

Specifically, acquiring the first control instruction by a processor includes but is not limited to following implementation manners.

A first implementation manner is acquiring a first remote instruction from a remote control, the remote control being adapted to the first physical robot.

A second implementation manner is acquiring a touch operation collected by a touch device and processing the touch operation to acquire the first control instruction.

A third implementation manner is acquiring a gesture image collected by an image acquisition device and processing the gesture image to acquire the first control instruction.

A fourth implementation manner is acquiring audio data collected by an audio collection device and processing the audio data to acquire the first control instruction.

The following describes how a processor controls the virtual robot to interact with the virtual component in the above four implementation manners.

(1) In a scenario when a user holds a remote control adapted to a first physical robot, and a distance to the first physical robot is within a coverage of a remote-control signal:

The user can press a button on the remote control to make the remote control generate a first remote instruction and transmit it to the processor. After receiving the first remote control instruction, the processor controls movement of the first physical robot, indirectly controls synchronous movement of the first virtual robot, and controls the first virtual robot to interact with the virtual component.

(2) In a scenario when a user does not have a remote control adapted to a first physical robot at hand, or a distance between the user and the first physical robot exceeds a coverage of a remote-control signal:

a) If the processor is connected to a touch device, the user can make a touch operation. The touch device collects the user's touch operation and transmits it to the processor. The processor determines the first control instruction after processing the touch operation, and accordingly controls movement of the first physical robot, indirectly controls synchronous movement of the first virtual robot, and controls an interaction between the first virtual robot and the virtual component.

b) If the processor is connected to an image acquisition device, the user can make a gesture. The image acquisition device collects the user's gesture image and transmits it to the processor. The processor determines the first control instruction after processing the gesture image, and accordingly controls movement of the first physical robot, indirectly controls synchronous movement of the first virtual robot, and controls an interaction between the first virtual robot and a virtual component.

c) If the processor is connected to an audio collection device, the user can speak an audio corresponding to the first control instruction. The audio collection device transmits collected audio data to the processor. The processor determines the first control instruction after processing the audio data, and accordingly controls movement of the first physical robot, indirectly controls synchronous movement of the first virtual robot, and controls an interaction between the first virtual robot and a virtual component.

Using the above technical solution, a user controls a physical robot to move in a real scene by pressing the remote control, making a touch operation, making a gesture, or speaking, etc., so that a virtual robot corresponding to the physical robot moves synchronously in a drawn virtual scene, so that the user controls the physical robot, and the corresponding virtual robot interacts with a virtual component in the drawn virtual scene, thereby improving interest of man-machine interaction.

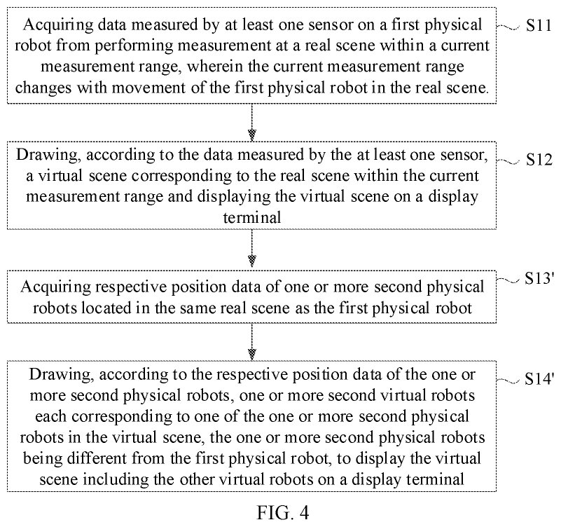

With reference to the above embodiment, in another embodiment of the present disclosure, referring to FIG. 4, FIG. 4 illustrates a flowchart of a virtual interaction method according to another embodiment of the present disclosure. As shown in FIG. 4, the method includes following steps in addition to step S11 and S12.

Step S13′: acquiring respective position data of one or more second physical robots located in a same real scene as the first physical robot.

Step S14′: drawing, according to the respective position data of the one or more second physical robots, one or more second virtual robots each corresponding to one of the one or more second physical robots in the virtual scene, the one or more second physical robots being different from the first physical robot, to display a virtual scene including the one or more second virtual robots on a display terminal.

In one embodiment, there are one or more second physical robots in the real scene where the first physical robot is located. That is, there are one or more physical robots in a same real scene as the first physical robot. In order to enable a user to see respective positions of the one or more second physical robots in the real scene where the first physical robot is located, the processor may acquire respective position data of the one or more second physical robots located in the same real scene as the first physical robot. Specifically, the one or more second physical robots located in the same real scene as the first physical robot each have a position sensor and are connected to the processor. Respective position sensors of the one or more second physical robots located in the same real scene as the first physical robot transmit measured position data to the processor.

After acquiring the respective position data of the one or more second physical robots and executing step S12, the processor may also continue to draw the one or more second virtual robots corresponding to the one or more second physical robots in the drawn virtual scene. Drawing the one or more second virtual robots corresponding to the one or more second physical robots is like drawing the first virtual robot corresponding to the first physical robot, which is not repeated herein.

Using the above technical solution, the one or more second virtual robots corresponding to the one or more second physical robots in a same real scene of a physical robot are superimposed in a drawn virtual scene and displayed on a display terminal. A user can learn positions of the one or more second physical robots in a real scene by watching a virtual scene of the one or more second virtual robots corresponding to the one or more second physical robots displayed on the display terminal, thereby improving visual interest.

In another embodiment, steps S13′, S14′ and S13 can all be implemented. Thus, all physical robots corresponding to their respective virtual robots are drawn in a drawn virtual scene and displayed on a display terminal. A user can learn relative positions of all physical robots in a real scene by watching a virtual scene containing corresponding virtual robots of all the physical robots displayed on the display terminal, thereby improving visual interest.

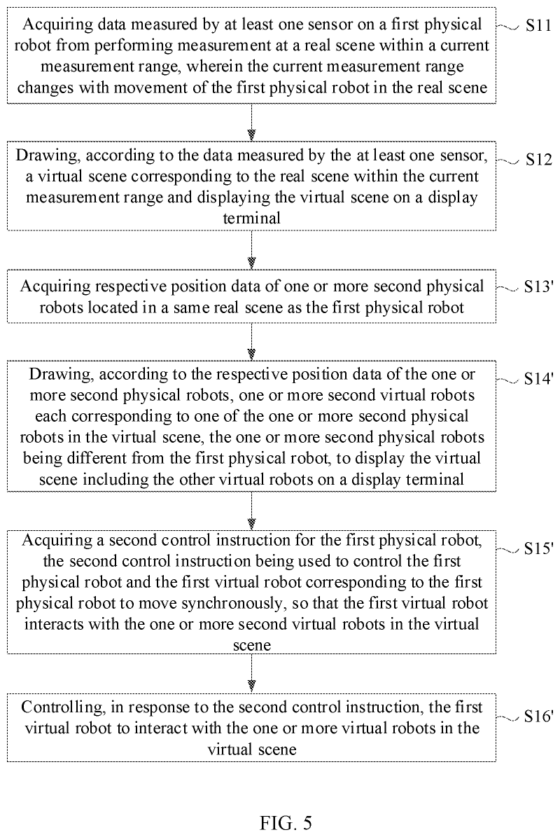

With reference to the above embodiment, in one embodiment of the present disclosure, referring to FIG. 5, FIG. 5 illustrates a flowchart of a virtual interaction method according to another embodiment of the present disclosure. As shown in FIG. 5, the method includes following steps in addition to steps S11, S12, S13′ and S14′.

Step S15′: acquiring a second control instruction for the first physical robot, the second control instruction being configured to control the first physical robot and the first virtual robot corresponding to the first physical robot to move synchronously, so that the first virtual robot interacts with the one or more second virtual robots in the virtual scene.

Step S16′: controlling, in response to the second control instruction, the first virtual robot to interact with the one or more second virtual robots in the virtual scene.

In one embodiment, all physical robots corresponding to their respective virtual robots are drawn in the drawn virtual scene, and displayed on the display terminal, so that after acquiring relative positions of all the physical robots in the real scene, if a user wants to experience interactions among a plurality of physical robots in a same real scene in the drawn virtual scene, the user may perform a control operation on the first physical robot and enable the processor to execute a step like S15 to acquire a second control instruction.

The following describes how a processor controls a first virtual robot to interact with one or more second virtual robots.

(1) In a scenario when a user holds a remote control adapted to a first physical robot, and a distance to the first physical robot is within a coverage of a remote-control signal,

The user can press a button on a remote control to make the remote control generate a first remote instruction and transmit it to the processor. After receiving the first remote control instruction, the processor controls movement of the first physical robot, indirectly controls synchronous movement of the first virtual robot, and controls the first virtual robot to interact with the one or more second virtual robots.

(2) In a scenario when a user does not have a remote control adapted to a first physical robot at hand, or a distance between the user and the first physical robot exceeds a coverage of a remote-control signal:

a) If the processor is connected to a touch device, the user can make a touch operation. The touch device collects the user's touch operation and transmits it to the processor. After processing the touch operation, the processor determines the first control instruction, controls movement of the first physical robot, indirectly controls synchronous movement of a first virtual robot, and controls the first virtual robot to interact with the one or more second virtual robots.

b) If the processor is connected to an image acquisition device, the user can make a gesture. The image acquisition device collects the user's gesture image and transmits it to the processor. After processing the gesture image, the processor determines the first control instruction, controls movement of the first physical robot, indirectly controls synchronous movement of the first virtual robot, and controls the first virtual robot to interact with the one or more second virtual robots.

c) If the processor is connected to an audio collection device, the user can speak an audio corresponding to the first control instruction. The audio collection device transmits collected audio data to the processor. The processor determines the first control instruction after processing the audio data, controls movement of the first physical robot, indirectly controls synchronous movement of the first virtual robot, and controls the first virtual robot to interact with the one or more second virtual robots.

Using the above technical solution, a user controls a physical robot to move in a real scene by pressing the remote control, making a touch operation, making a gesture, or speaking, etc., so that a virtual robot corresponding to the physical robot moves synchronously in a drawn virtual scene, so that the user controls the physical robot, and the corresponding virtual robot interacts with the one or more second virtual robots in the drawn virtual scene, thereby improving interest of man-machine interaction.

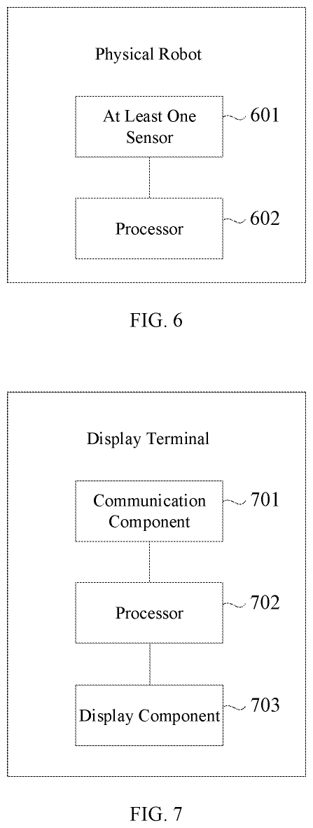

Based on a same inventive concept, one embodiment of the present disclosure provides a physical robot. The physical robot may be a first physical robot in the above embodiments or any physical robot other than the first physical robot. Referring to FIG. 6, FIG. 6 illustrates a schematic diagram of a physical robot according to an embodiment of the present disclosure. As shown in FIG. 6, the physical robot includes: at least one sensor 601, configured to perform measurement at a real scene within a current measurement range; and a processor 602, connected to the at least one sensor, configured to obtain data measured by the at least one sensor on the physical robot from performing the measurement at the real scene within a current measurement range, and execute the virtual interaction method described in the above embodiments of the present disclosure.

Based on a same inventive concept, one embodiment of the present disclosure provides a display terminal. Referring to FIG. 7, FIG. 7 illustrates a schematic diagram of a display terminal according to an embodiment of the present disclosure. As shown in FIG. 7, the display terminal includes: a communication component 701, configured to communicate with a first physical robot to obtain data when at least one sensor on a first physical robot performs measurement at a real scene within a current measurement range; a processor 702, configured to execute the virtual interaction method described in each of the above-mentioned embodiments of the present disclosure; and a display component 703, connected to the processor, configured to display a virtual scene corresponding to a real scene within the current measurement range. In some embodiments, the processor includes a graphics processing unit (GPU).

Optionally, the display component is a touch screen for collecting a touch operation; or a touch panel is integrated in the display terminal, connected to the processor, and used to collect a touch operation.

Optionally, an image acquisition component is integrated in the display terminal, connected to the processor, and used to collect a gesture image.

Optionally, an audio collection component is integrated in the display terminal, connected to the processor, and used to collect audio data.

Optionally, the display terminal is a smart glass, a smart phone or a tablet computer.

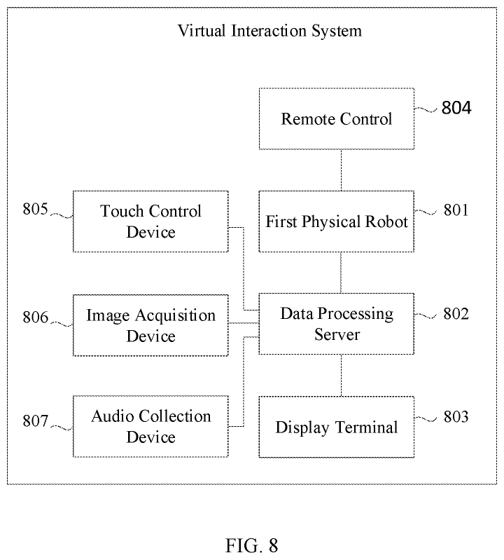

Based on a same inventive concept, one embodiment of the present disclosure provides a virtual interaction system. Referring to FIG. 8, FIG. 8 illustrates a schematic diagram of a virtual interaction system according to an embodiment of the present disclosure. As shown in FIG. 8, the virtual interaction system includes: a first physical robot 801 with at least one sensor configured to perform measurement at a real scene within a current measurement range; and a data processing server 802, connected to a first physical robot, and used to execute the method described in the first aspect of the present disclosure.

Optionally, as shown in FIG. 8, the system further includes a display terminal 803, connected to the data processing server, and used to display a virtual scene corresponding to the real scene within the current measurement range.

Optionally, the system further includes a remote control 804, adapted to the first physical robot, and used to generate a first remote instruction.

Optionally, the system further includes a touch control device 805, connected to the data processing server, and used to collect a touch operation.

Optionally, the system further includes an image acquisition device 806, connected to the data processing server, and used to acquire a gesture image.

Optionally, the system further includes an audio collection device 807, connected to the data processing server, and used to collect audio data.

Based on a same inventive concept, another embodiment of the present disclosure provides a computer-readable storage medium on which a computer program is stored. When the program is executed by a processor, steps in the method described in any of the above embodiments of the present disclosure are implemented.

Based on a same inventive concept, another embodiment of the present disclosure provides an electronic device, including a memory, a processor, and a computer program stored on the memory and capable of running on the processor. When executing the computer program, the process implements steps in a method described in any of the above embodiments of the present disclosure.

Since device embodiments are basically like method embodiments, descriptions of the device embodiment are relatively simple. For details about the device embodiments, refer to related parts of descriptions of the method embodiments.

Each embodiment in the present specification is described in a progressive manner. Each embodiment focuses on differences from other embodiments. Same or similar parts between the embodiments can be referred to each other.

Those skilled in the art should understand that the embodiments of the present disclosure provide methods, devices, or computer program products. Therefore, the embodiments of the present disclosure may adopt a form of a complete hardware embodiment, a complete software embodiment, or an embodiment combining software and hardware. Moreover, the embodiments of the present disclosure may adopt a form of a computer program product implemented on one or more computer-usable storage media (including but not limited to disk storage, CD-ROM, optical storage, etc.) containing computer-usable program codes.

The embodiments of the present disclosure are described with reference to flowcharts and/or block diagrams of methods, terminal devices (systems), and computer program products according to the embodiments of the present disclosure. It should be understood that each process and/or block in a flowchart and/or a block diagram, and a combination of processes and/or blocks in the flowchart and/or block diagram can be implemented by computer program instructions. The computer program instructions can be provided to a processor of a general-purpose computer, a special-purpose computer, an embedded processing machine, or other programmable data processing terminal device to generate a machine, so that instructions executed by the processor of the computer or other programmable data processing terminal device to generate a device for implementing functions specified in one flow or a plurality of flows in the flowchart and/or one block or a plurality of blocks in the block diagram.

The computer program instructions can also be stored in a computer-readable memory that can guide a computer or other programmable data processing terminal device to work in a specific manner, so that the instructions stored in the computer-readable memory produce a manufactured product including an instruction device. The instruction device implements functions specified in one or more flows in the flowchart and/or one or more blocks in the block diagram.

The computer program instructions can also be loaded on a computer or other programmable data processing terminal device, so that a series of operation steps are executed on the computer or the other programmable terminal device to produce computer-implemented processing. Thereby, the instructions executed on the computer or the other programmable terminal device provide steps for implementing functions specified in one or more flows in the flowchart and/or one or more blocks in the block diagram.

Although preferred embodiments of the embodiments of the present disclosure have been described, those skilled in the art can make additional changes and modifications to the embodiments once knowing basic creative concepts. Therefore, appended claims are intended to be interpreted as including the preferred embodiments and all changes and modifications falling within the scope of the embodiments of the present disclosure.

Finally, it should be noted that in the present specification, relationship terms such as first and second are only used to distinguish one entity or operation from another entity or operation, and do not necessarily require or imply that there is any such actual relationship or order between these entities or operations. Furthermore, terms “include”, “comprise” or any other variants thereof are intended to cover non-exclusive inclusions, so that a process, method, article or terminal device that includes a list of elements is not only limited to those elements, but may include other elements not explicitly listed, or inherent to the process, method, article, or terminal device. Without more restrictions, an element defined by a sentence “includes a . . . ” does not exclude an existence of other identical elements in a process, method, article, or terminal device that includes the element.

A method, device, a storage medium, and an electronic device for virtual interaction provided by the present disclosure are described in detail above. In the present disclosure, specific examples are used to illustrate principles and implementation manners of the present disclosure. The description of the above embodiments is only used to help understand methods and core ideas of the present disclosure. At a same time, for those skilled in the art, according to ideas of the present disclosure, there will be changes in the specific implementation manner and application scope. In summary, the content of the present specification should not be construed as a limitation of the present disclosure.

What is claimed is:

1. A method for virtual interaction, comprising:
acquiring data measured by at least one sensor of a first physical robot from performing measurement at a real scene within a current measurement range, wherein the current measurement range changes with a movement of the first physical robot in the real scene; and
drawing, according to the data measured by the at least one sensor, a virtual scene corresponding to the real scene within the current measurement range, and displaying the virtual scene on a display terminal.

2. The method according to claim 1, wherein the at least one sensor includes a position sensor, and the method further includes:
drawing, according to position data measured by the position sensor, a first virtual robot corresponding to the first physical robot in the virtual scene; and
displaying the virtual scene containing the first virtual robot on the display terminal, comprising:
synchronously displaying a movement of the first virtual robot in the virtual scene according to the movement of the first physical robot in the real scene.

3. The method according to claim 2, further comprising:
drawing, according to the data measured by the at least one sensor, a virtual component in the virtual scene;
displaying the virtual scene containing the virtual component on the display terminal;
acquiring a first control instruction for the first physical robot, the first control instruction being configured to control the first physical robot and the first virtual robot to move synchronously; and
controlling, in response to the first control instruction, the first virtual robot to interact with the virtual component in the virtual scene.

4. The method according to claim 1, further comprising:
acquiring respective position data of one or more second physical robots in a same real scene as the first physical robot;
drawing, according to the respective position data of the one or more second physical robots, one or more second virtual robots each corresponding to one of the one or more second physical robots in the virtual scene, the one or more second physical robots being different from the first physical robot; and
displaying the virtual scene containing the one or more second virtual robots on the display terminal.

5. The method according to claim 4, further comprising:
acquiring a second control instruction for the first physical robot, the second control instruction being configured to control the first physical robot and the first virtual robot to move synchronously; and
controlling, in response to the second control instruction, the first virtual robot to interact with the one or more second virtual robots in the virtual scene.

6. The method according to claim 3, wherein the first physical robot is coupled to a remote control, and acquiring the first control instruction for the first physical robot includes:
acquiring a first remote instruction from the remote control.

7. The method according to claim 3, wherein acquiring the first control instruction for the first physical robot includes:
acquiring a touch operation collected by a touch device, and
processing the touch operation to acquire the first control instruction.

8. The method according to claim 3, wherein acquiring the first control instruction for the first physical robot includes:
acquiring a gesture image collected by an image acquisition device; and
processing the gesture image to acquire the first control instruction.

9. The method according to claim 3, wherein acquiring the first control instruction for the first physical robot includes:
acquiring audio data collected by an audio collection device; and
processing the audio data to acquire the first control instruction.

10. A first physical robot, comprising:
at least one sensor, configured to perform measurement at a real scene within a current measurement range, wherein the current measurement range changes with a movement of the first physical robot in the real scene; and
a processor, connected to the at least one sensor, configured to obtain data measured by the at least one sensor from performing the measurement at the real scene within the current measurement range, and draw, according to the data measured by the at least one sensor, a virtual scene corresponding to the real scene within the current measurement range, the virtual scene being displayed on a display terminal.

11. The first physical robot according to claim 10, wherein the at least one sensor includes a position sensor, and the processor is further configured to:
draw, according to position data measured by the position sensor, a first virtual robot corresponding to the first physical robot in the virtual scene; and
display the virtual scene containing the first virtual robot on the display terminal, comprising:
synchronously displaying a movement of the first virtual robot in the virtual scene according to the movement of the first physical robot in the real scene.

12. The first physical robot according to claim 11, wherein the processor is further configured to:
draw, according to the data measured by the at least one sensor, a virtual component in the virtual scene;
display the virtual scene containing the virtual component on the display terminal;
acquire a first control instruction for the first physical robot, the first control instruction being configured to control the first physical robot and the first virtual robot to move synchronously; and
control, in response to the first control instruction, the first virtual robot to interact with the virtual component in the virtual scene.

13. The first physical robot according to claim 10, wherein the processor is further configured to:
acquire respective position data of a plurality of second physical robots in a same real scene as the first physical robot;
draw, according to the respective position data of the plurality of second physical robots, second virtual robots corresponding to each of the plurality of second physical robots in the virtual scene, the plurality of second physical robots being physical robots different from the first physical robot; and
display the virtual scene containing the second virtual robots on the display terminal.

14. The first physical robot according to claim 13, wherein the processor is further configured to:
acquire a second control instruction for the first physical robot, the second control instruction being configured to control the first physical robot and the first virtual robot to move synchronously; and
control, in response to the second control instruction, the first virtual robot to interact with the second virtual robots in the virtual scene.

15. The first physical robot according to claim 12, wherein when acquiring the first control instruction for the first physical robot, the processor is further configured to perform at least one of:
acquiring a first remote instruction from a remote control coupled to the first physical robot and processing the first remote instruction to acquire the first control instruction;
acquiring a touch operation collected by a touch device, and processing the touch operation to acquire the first control instruction;
acquiring a gesture image collected by an image acquisition device, and processing the gesture image to acquire the first control instruction; or
acquiring audio data collected by an audio collection device, and processing the audio data to acquire the first control instruction.

16. A display terminal, comprising:
a communication component, configured to communicate with a first physical robot to obtain data measured by at least one sensor on a first physical robot from performing measurement at a real scene within a current measurement range, wherein the current measurement range changes with a movement of the first physical robot in the real scene;
a processor, configured to draw, according to the data measured by the at least one sensor, a virtual scene corresponding to the real scene within the current measurement range; and
a display component, connected to the processor, configured to display the virtual scene corresponding to the real scene within the current measurement range.

17. The display terminal according to claim 11, wherein:
the display component is a touch screen configured to collect a touch operation; or a touch panel integrated in the display terminal, connected to the processor, and configured to collect the touch operation; and
the processor is further configured to
draw, according to the data measured by the at least one sensor, a virtual component in the virtual scene, the virtual scene containing the virtual component being displayed by the display component;
process the touch operation to acquire a first control instruction for the first physical robot, the first control instruction being configured to control the first physical robot and the first virtual robot to move synchronously; and
control, in response to the first control instruction, the first virtual robot to interact with the virtual component in the virtual scene.

18. The display terminal according to claim 11, wherein:
an image acquisition component is integrated in the display terminal, connected to the processor, and configured to collect a gesture image; and
the processor is further configured to
draw, according to the data measured by the at least one sensor, a virtual component in the virtual scene, the virtual scene containing the virtual component being displayed by the display component;
process the gesture image to acquire a first control instruction for the first physical robot, the first control instruction being configured to control the first physical robot and the first virtual robot to move synchronously; and
control, in response to the first control instruction, the first virtual robot to interact with the virtual component in the virtual scene.

19. The display terminal according to claim 11, wherein:
an audio collection component is integrated in the display terminal, connected to the processor, and configured to collect audio data; and
the processor is further configured to
draw, according to the data measured by the at least one sensor, a virtual component in the virtual scene, the virtual scene containing the virtual component being displayed by the display component;
process the audio data to acquire a first control instruction for the first physical robot, the first control instruction being configured to control the first physical robot and the first virtual robot to move synchronously; and
control, in response to the first control instruction, the first virtual robot to interact with the virtual component in the virtual scene.

20. The display terminal according to claim 11, wherein the display terminal is at least one of a smart glass, a smart phone or a tablet computer.
